(19) United States
(12) Patent Application Publication
(10) Pub. No.: US 2025/0148563 A1
(43) Pub. Date: May 8, 2025

(54) SYSTEMS AND METHODS FOR ARRANGING HOME SHARE AND CORRESPONDING GROUND TRANSPORTATION

(71) Applicant: Larry B. Britt, Corrales, NM (US)

(72) Inventor: Larry B. Britt, Corrales, NM (US)

(21) Appl. No.: 18/503,946

(22) Filed: Nov. 7, 2023

(51) Int. Cl. G06Q 50/30; G06Q 50/12

(52) U.S. Cl. CPC G06Q 50/40; G06Q 50/12

(57) ABSTRACT

A system for determining the need for, and providing, a home share and corresponding transport service when a user's flight has been cancelled or significantly delayed is disclosed. When a user's flight is cancelled or significantly delayed, a user is provided a list of home shares to utilize for the night, along with corresponding transport service to each of the home shares. This list can be arranged and filtered by price, time of arrival, etc.

### TECHNICAL FIELD

The present invention is directed to scheduling logistics of home share and ground transportation services, and more particularly to utilizing computer-implemented systems to arranging home share and corresponding ground transportation to users based on flight status.

### BACKGROUND ART

Ground transportation services such as ride share services are ubiquitous now. A user can easily get on any number of applications and be connected directly to a driver. The driver sees the exact location of the user based on the user's device. The payment is made through the application.

There is an abundance of prior art directed to the concept of ride share and similar concepts of tracking.

US20170053370A1 titled “System and methods for arranging ground transportation for a debarking air traveler based on curb arrival time” to Charles Ogilvie a computer-implemented system for arranging ground transportation to air travels as they debark their plane based on curb arrival time.

U.S. Pat. No. 9,846,041B2 titled “Time regulated navigation of travel through an airport” to Dana Lu Silverstein provides a system that provides real time traffic and delay information for travelers in the airport.

U.S. Pat. No. 9,852,551B2 titled “Programmatically determining location information in connection with a transport service” to Kevin Brinig et al. provides a system for determining location information in connection with a transport service.

U.S. Pat. No. 10,147,154B2 titled “System to facilitate a correct identification of a service provider” to Ziv Haparnas et al., U.S. Pat. No. 10,356,548B2 titled “System and method for improved passenger boarding” to David Brukman, U.S. Pat. No. 11,279,481 titled “Systems and methods for tracking, evaluating and determining a response to emergency situations using unmanned airborne vehicles” to Philip E. Burks et al., US20170046636A1 titled “Method and system for providing travel support services” to Henry Y. Neal et al., and US20170132823A1 titled “Using augmented reality to determine information” to Kamal Zamer each further provide systems and/or methods for providing travel related services, tracking, scheduling, etc.

When flights are cancelled, everyone scrambles to find a place to stay, along with arranging transportation to same. None of the prior art addresses this situation all in one click. As of now, if a user needs a place to stay for the night, they must look around and find a suitable place, and then secure a ride, typically through a ride share application.

The present invention overcomes the shortcomings contained in the prior art by providing a system and method that can track the status of flights and pre-emptively provide a listing of suitable home shares (or other suitable place to stay like a hotel), and a corresponding ride share to the home share. This could be a service that airlines offer, and individuals agree to. Once a flight is cancelled, the user who has signed up for the service application of the present invention will get a notification with a list of home shares and ride shares. The user simply clicks on the option they want, and the home share and ride share are scheduled automatically through any number of third party applications or websites.

None of the prior art fully addresses the problems resolved by the present invention. The present invention overcomes these limitations contained in the prior art.

Certain embodiments of the invention have other steps or elements in addition to or in place of those mentioned above. The steps or element will become apparent to those skilled in the art from a reading of the following detailed description when taken with reference to the accompanying figures, if any.

### BRIEF DESCRIPTION OF THE DRAWINGS

FIG. 1 illustrates the steps of method for arranging home share and corresponding ground transportation.

FIG. 2 illustrates the steps of method for arranging home share and corresponding ground transportation.

FIG. 3 illustrates the steps for a non-transitory computer-readable medium storing instructions that, when executed by a computing system, cause the computing system to perform the steps.

### DETAILED DESCRIPTION OF THE INVENTION

The best mode for carrying out the invention will be described herein. The following embodiments are described in sufficient detail to enable those skilled in the art to make and use the invention. It is to be understood that other embodiments would be evident based on the present disclosure, and that system, process, or mechanical changes may be made without departing from the scope of the present invention.

In the following description, numerous specific details are given to provide a thorough understanding of the invention. However, it will be apparent that the invention may be practiced without these specific details. To avoid obscuring the present invention, some well-known system configurations, and process steps are not disclosed in detail. The figures illustrating embodiments of the system, if any, are semi-diagrammatic and not to scale and, particularly, some of the dimensions are for the clarity of presentation and are shown exaggerated in the drawing figures.

Alternate embodiments have been included throughout, and the order of such are not intended to have any other significance or provide limitations for the present invention.

The words “including”, “comprising”, “incorporating”, “consisting of”, “have”, and “is” are meant to be non-exclusive, meaning additional items, components or elements may be present. Joinder references such as “connected”, “connecting”, and “coupled” do not limit the position, orientation, or use of systems and/or methods, and do not necessarily infer that two elements are directly connected. All identifying numerical terms are for identification only, and do not refer to the order or preference of any element, embodiment, variation and/or modification.

The present disclosure provides a method of programmatically determining information in connection with a transport service and a home share service based on flight status, the method being performed by a computing system and comprising the steps of: determining, by the computing system, the need for a home share and a corresponding transport service for a user when a flight has been cancelled or significantly delayed; determining, by the computing system, a list of one or more home shares from one or more home share services for the user to utilize; determining, by the computing system, a list of transport services to be provided by a driver to take the user to any of the one or more home shares; sending, by the computing system, the listing of home shares and corresponding transport services to a user device, wherein the user selects the desired home share and corresponding transport service to the home share; arranging, by the computing system, the desired home share from the home share service and corresponding transport service to the home share; and sending, by the computing system, the data from the selected home share service and corresponding transport service to the user device, wherein the driver is provided the location of the user, wherein the user is connected to the transport service to track the driver, and wherein the driver is provided the location of the home share.

The present disclosure further provides a method comprising the steps of: receiving a request from a user for service from a user device; transmitting the request to a computing system; determining, by the computing system, the availability of home shares and corresponding transport services for the user; determining, by the computing system, a list of one or more home shares from one or more home share services for the user to utilize; determining, by the computing system, a list of transport services to be provided by a driver to take the user to any of the one or more home shares; sending, by the computing system, the listing of home shares and corresponding transport services to the user device, wherein the user selects the desired home share and corresponding transport service to the home share on the user device; arranging, by the computing system, the desired home share from the home share service and corresponding transport service to the home share; and sending, by the computing system, the data from the selected home share service and corresponding transport service to the user device, wherein the driver is provided the location of the user, wherein the user is connected to the transport service to track the driver, and wherein the driver is provided the location of the home share.

The present disclosure further provides a non-transitory computer-readable medium storing instructions that, when executed by a computing system, cause the computing system to determine, by the computing system, the need for a home share and a corresponding transport service for a user when a flight has been cancelled or significantly delayed; determine, by the computing system, a list of one or more home shares from one or more home share services for the user to utilize; determine, by the computing system, a list of transport services to be provided by a driver to take the user to any of the one or more home shares; send, by the computing system, the listing of home shares and corresponding transport services to a user device, wherein the user selects the desired home share and corresponding transport service to the home share on the user device; arrange the desired home share from the home share service and corresponding transport service to the home share in response to receiving the selection of home share and corresponding transport service; send, by the computing system, the data from the selected home share service and corresponding transport service to the user device, wherein the driver is provided the location of the user, wherein the user is connected to the transport service to track the driver, and wherein the driver is provided the location of the home share.

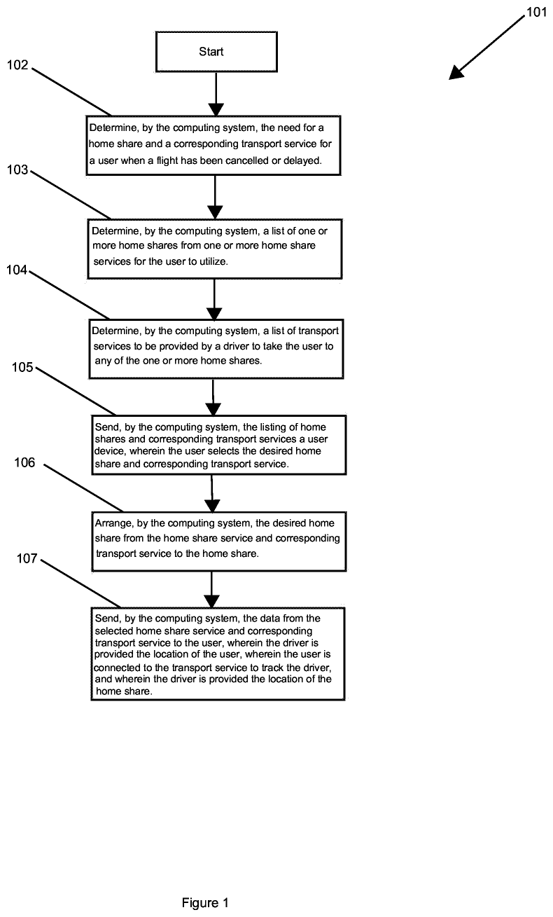

FIG. 1 illustrates the steps of method 101 of programmatically determining information in connection with a transport service and a home share service based on flight status, the method being performed by a computing system. Method 101 comprises Steps 102-107. Step 102 comprises determining, by the computing system, the need for a home share and a corresponding transport service for a user when a flight has been cancelled or significantly delayed.

Step 103 comprises determining, by the computing system, a list of one or more home shares from one or more home share services for the user to utilize.

Step 104 comprises determining, by the computing system, a list of transport services to be provided by a driver to take the user to any of the one or more home shares.

Step 105 comprises sending, by the computing system, the listing of home shares and corresponding transport services to a user device, wherein the user selects the desired home share and corresponding transport service to the home share. In one embodiment, the user is provided a list of transport services based on the user's selection of the desired home share, which may be based on the location of the user's selected home share. The listing sent to the user device may be arranged by any number of factors, including, but not limited to, pricing, location, time of arrival to home share, proximity of driver to the user, etc. The list can also be filtered to show only certain home shares and transport services based on pricing, location, time of arrival, etc.

Step 106 comprises arranging, by the computing system, the desired home share from the home share service and corresponding transport service to the home share. The computing system communicates directly with the home share and transport service to arrange the services on user's behalf.

Step 107 comprises sending, by the computing system, the data from the selected home share service and corresponding transport service to the user device, wherein the driver is provided the location of the user, the driver is provided the location of the user, and wherein the driver is provided the location of the home share.

The computing system may comprise an application that a user can access via the user device. The user device comprises any type of computer, phone, digital device, etc., that allows the user to access the application that provides access to the computing system.

The computing system communicates with any number of third-party, or in-house, services that provide home share and/or transport services. The home share services allow a user to book a room at a hotel, motel, bed and breakfast, inn, time share, house or room rental, or any other place to stay for at least the night. The transport services allow a user to book a ride to any home share service. A “transport service” is any service that connects the user with a mode of transportation to a home share, including, but not limited to, a cab, ride share, bus, train, private limousine, etc. A “home share”, as that term is used herein, refers to anywhere a user may book a room or place to stay, including, but not limited to, a hotel, motel, bed and breakfast, condominium, hostel, inn, time share, house, room rental, etc. A “home share service” is any service that connects the user with a home share.

Hosts on the home share services may offer some type of “airport stranded” options as part of a home share profile. If a host opts in to such an option, this would allow shorter than normal booking times as the home share would need to be ready very quickly. The premium price for such “airport stranded” bookings could vary based on the hosts' preferences. This additional premium pricing could be built into the service application of the present invention, or into the home share service itself.

Payment for the home share and transport services may be made through the application of the present invention, or user may be redirected to the specific home share and/or transport services.

The user may subscribe or otherwise consent to the use of method 101 when purchasing a flight reservation and/or when setting up their account with an airline (i.e., customer/passenger would need to uncheck a box that says, “Do not provide my information to home share functionality when flights are cancelled or significantly delayed.”). This would require the user to register a phone number, email, or other notification service to allow the computing system to communicate with the user. This would also grant access to the user's flight information to the computing system. If the flight was cancelled or significantly delayed, the user would notified via the user's device as in step 105.

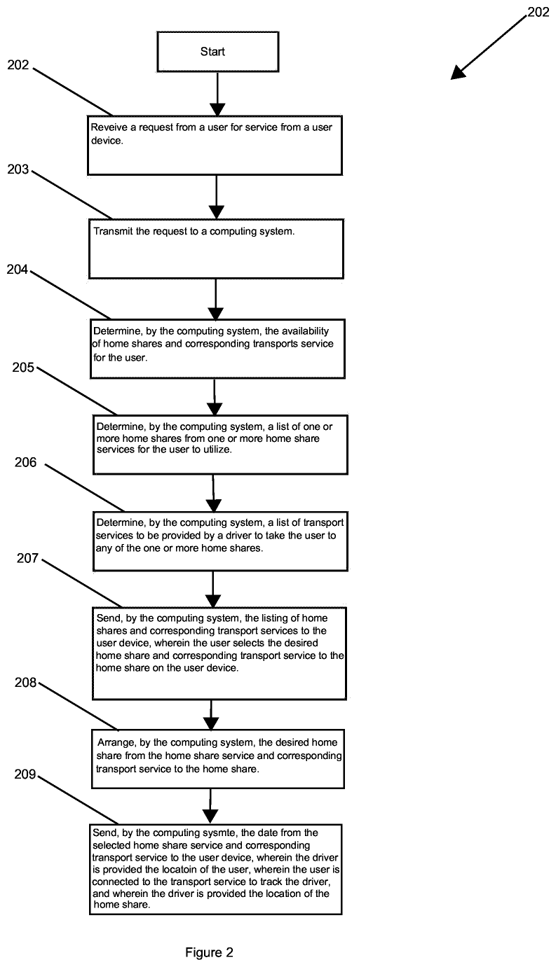

FIG. 2 illustrates the steps of method 202 for arranging home share and corresponding ground transportation. Method 201 comprises Steps 202-209. Step 202 comprises receiving a request from a user for service from a user device.

Step 203 comprises transmitting the request to a computing system.

Step 204 comprises determining, by the computing system, the availability of home shares and corresponding transport services for the user.

Step 205 comprises determining, by the computing system, a list of one or more home shares from one or more home share services for the user to utilize.

Step 206 comprises determining, by the computing system, a list of transport services to be provided by a driver to take the user to any of the one or more home shares.

Step 207 comprises sending, by the computing system, the listing of home shares and corresponding transport services to the user device, wherein the user selects the desired home share and corresponding transport service to the home share on the user device.

Step 208 comprises arranging, by the computing system, the desired home share from the home share service and corresponding transport service to the home share.

Step 209 comprises sending, by the computing system, the data from the selected home share service and corresponding transport service to the user device, wherein the driver is provided the location of the user, wherein the user is connected to the transport service to track the driver, and wherein the driver is provided the location of the home share.

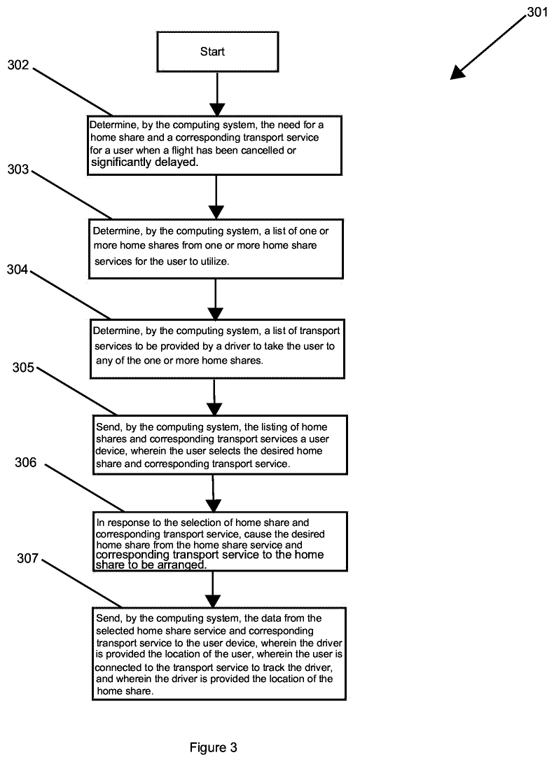

FIG. 3 illustrates the steps of method 301 for a non-transitory computer-readable medium storing instructions that, when executed by a computing system, cause the computing system to perform steps 302-307. Step 302 comprises determining, by the computing system, the need for a home share and a corresponding transport service for a user when a flight has been cancelled or significantly delayed.

Step 303 comprises determining, by the computing system, a list of one or more home shares from one or more home share services for the user to utilize.

Step 304 comprises determining, by the computing system, a list of transport services to be provided by a driver to take the user to any of the one or more home shares.

Step 305 comprises sending, by the computing system, the listing of home shares and corresponding transport services to a user device, wherein the user selects the desired home share and corresponding transport service to the home share on the user device.

Step 306 comprises arranging the desired home share from the home share service and corresponding transport service to the home share in response to receiving the selection of home share and corresponding transport service.

Step 307 comprises sending, by the computing system, the data from the selected home share service and corresponding transport service to the user device, wherein the driver is provided the location of the user, wherein the user is connected to the transport service to track the driver, and wherein the driver is provided the location of the home share.

The computing system is the same across all methods 101, 201, and 301, and is any appropriate computing system that achieves the desired result. The present invention can be implemented by and operated on a computing device and/or computing system, or on any number of computing devices and/or computing systems. All references to computing systems may also comprise computing devices.

The present invention may utilize a network service comprising servers, additional computing systems, or other components that allow the computing system to access the necessary information relating to flight statuses, home shares, and transport services, and to provide that information to the user device.

The user device may comprise an application that allows access to the computing system of the present invention that receives information from the computing system via the network service.

Any of the steps may be omitted, combined, or other steps added to the various methods.

The computing system may communicate with flight tracking as provided by airlines, airports, etc., such as Flightaware, flight radar, and other applications that can see well in advance issues within the airline network. These third-party applications and services communicate with the computing system of the present invention to let nearby home share hosts know there may be issues and to be on alert.

Airline may pay for home share and transport service via the system of the present invention based on flight status and arrange for the home share and transport service. The airline may provide a portion, or all of the cost, based on the passenger's status within the airline's loyalty program.

In another embodiment, restaurants are also provided by the computing system based on the desired home share and transport service, with the user given options of restaurants on the route to the home share. Food delivery options may also be provided in the system of the present invention, such that a user can order food that is in the range of the desired home share. This food could be ordered through the service of the present invention, and the service of the present invention would communicate with the third-party food delivery application service.

Basic items, like toiletry kits, pajamas, tooth brush, etc. may also be offered for purchase through the system of the present invention.

The present invention is not only limited to the use for flight delays. The present invention may also be implemented in any number of situations other than flight delays whereby a user is in the need of a home share and corresponding transport services.

The present invention overcomes the shortcomings contained in the prior art by providing a system and method that can track the status of flights and pre-emptively provide a listing of suitable home shares (or other suitable place to stay like a hotel), and a corresponding ride share to the home share. This could be a service that airlines offer, and users agree to. Once a flight is cancelled, every user who has signed up will get a notification with a list of home shares and ride shares. The user simply clicks on the option they want, and the home share and ride share are scheduled automatically through any number of third party, or in-house, applications or websites.

Additional elements and/or steps may be added or removed to the present invention, as desired.

All references to “a” and “an”, as in “a computing system”, mean “one or more”.

The best mode for carrying out the invention has been described herein. The previous embodiments are described in sufficient detail to enable those skilled in the art to make and use the invention. It is to be understood that other embodiments would be evident based on the present disclosure, and that system, process, or mechanical changes may be made without departing from the scope of the present invention.

In the previous description, numerous specific details and examples are given to provide a thorough understanding of the invention. However, it will be apparent that the invention may be practiced without these specific details and specific examples. While the invention has been described in conjunction with a specific best mode, it is to be understood that many alternatives, modifications, and variations will be apparent to those skilled in the art in light of the foregoing description. Accordingly, it is intended to embrace all such alternatives, modifications, and variations that fall within the scope of the included claims. All matters previously set forth herein or shown in the accompanying figures are to be interpreted in an illustrative and non-limiting sense.

What is claimed is:

1. A method of programmatically determining information in connection with a transport service and a home share service based on flight status, the method being performed by a computing system and comprising:
determining, by the computing system, the need for a home share and a corresponding transport service for a user when a flight has been cancelled or significantly delayed;
determining, by the computing system, a list of one or more home shares from one or more home share services for the user to utilize;
determining, by the computing system, a list of transport services to be provided by a driver to take the user to any of the one or more home shares;
sending, by the computing system, the listing of home shares and corresponding transport services to a user device,
wherein the user selects the desired home share and corresponding transport service to the home share;
arranging, by the computing system, the desired home share from the home share service and corresponding transport service to the home share; and
sending, by the computing system, the data from the selected home share service and corresponding transport service to the user device,
wherein the driver is provided the location of the user,
wherein the user is connected to the transport service to track the driver, and
wherein the driver is provided the location of the home share.

2. The method of claim 1, wherein the computing system comprises an application that the user accesses via the user device.

3. The method of claim 2, wherein the payment for the home share and transport service is done through the application.

4. The method of claim 1, wherein the user is provided a list of transport services based on the user's selection of the desired home share.

5. The method of claim 1, wherein the listing of home shares and corresponding transport services provided to the user are arranged via pricing.

6. The method of claim 1, wherein the listing of home shares and corresponding transport services provided to the user are arranged via location.

7. The method of claim 1, wherein the listing of home shares and corresponding transport services provided to the user are arranged via driver proximity to the user.

8. The method of claim 1, wherein the payment for the home share and transport service is done through the respective home share and transport service applications.

9. The method of claim 1, wherein the user subscribes to the computing system when purchasing a flight reservation.

10. A method comprising:
receiving a request from a user for service from a user device;
transmitting the request to a computing system;
determining, by the computing system, the availability of home shares and corresponding transport services for the user;
determining, by the computing system, a list of one or more home shares from one or more home share services for the user to utilize;
determining, by the computing system, a list of transport services to be provided by a driver to take the user to any of the one or more home shares;
sending, by the computing system, the listing of home shares and corresponding transport services to the user device,
wherein the user selects the desired home share and corresponding transport service to the home share on the user device;
arranging, by the computing system, the desired home share from the home share service and corresponding transport service to the home share; and
sending, by the computing system, the data from the selected home share service and corresponding transport service to the user device,
wherein the driver is provided the location of the user,
wherein the user is connected to the transport service to track the driver, and
wherein the driver is provided the location of the home share.

11. The method of claim 10, wherein the computing system utilizes any number of home share services and transport services to determine the availability and prepare the list of the available home shares and corresponding transport services.

12. The method of claim 10, wherein the computing system comprises an application that the user accesses via the user device.

13. A non-transitory computer-readable medium storing instructions that, when executed by a computing system, cause the computing system to:
determine, by the computing system, the need for a home share and a corresponding transport service for a user when a flight has been cancelled or significantly delayed;
determine, by the computing system, a list of one or more home shares from one or more home share services for the user to utilize;
determine, by the computing system, a list of transport services to be provided by a driver to take the user to any of the one or more home shares;
send, by the computing system, the listing of home shares and corresponding transport services to a user device,
wherein the user selects the desired home share and corresponding transport service to the home share on the user device;
arrange the desired home share from the home share service and corresponding transport service to the home share in response to receiving the selection of home share and corresponding transport service;
send, by the computing system, the data from the selected home share service and corresponding transport service to the user device,
wherein the driver is provided the location of the user,
wherein the user is connected to the transport service to track the driver, and
wherein the driver is provided the location of the home share.

14. The method of claim 13, wherein the computing system comprises an application that the user accesses via the user device.
